(19) United States
(12) Patent Application Publication
(10) Pub. No.: US 2008/0313958 A1
(43) Pub. Date: Dec. 25, 2008

(54) Method for drying cane

(76) Inventor: Devanand S. Pachanoor, Hauppauge, NY (US)

Correspondence Address: ALIX YALE & RISTAS LLP, 750 MAIN STREET, SUITE 1400, HARTFORD, CT, 06103, US

(21) Appl. No.: 11/821,673

(22) Filed: Jun. 25, 2007

(51) Int. Cl. A01D 91/00

(52) U.S. Cl. 47/58.1 LS

(57) ABSTRACT

During or closely following harvesting of the cane plant, each plant is trimmed by removing the nodes and associated leaves, thereby forming raw tubes from each remaining internode segment. The raw tubes are artificially dried and then exposed to artificial light, to produce finished tubes. The improved process reduces the time between the harvesting of a plant to the completion of a finished tube, from a period that is typically measured in months to a period measured in weeks. Furthermore, it has been found that the artificial drying is so effective that harvesting and processing of the reed cane can continue throughout the year, thereby increasing productivity and responsiveness to fluctuations in demand.

### BACKGROUND

The present invention relates to the production of reed tubes from harvested cane plants.

So-called “reed cane” (Arundo donax L.) has for centuries, been used for the production of musical instrument reeds for, e.g., bassoons, oboes, saxophones, clarinets, etc. The cane plant has a rhizome system beneath the ground surface, a stem or stalk that can grow to three or four meters in height, and leaves which grow outward from the stem at points typically referred to as nodes. The composition of the stem has three concentric rings: (1) a hard waxy epidermis and outer cortical cells; (2) a thick sclerified fiber band; and (3) a thick inner cortex. The first may be considered a rind or bark, whereas the third may be considered the pith. In between, the second (fiber band) is typically a thin brownish ring. The strength of the two outer ring allows the reed maker to form a stable tube for, e.g., a bassoon reed. On the blades of the reed, these layers are profiled or scraped away to expose cells of the inner cortex, which are flexible enough to vibrate easily.

Such wild cane is also known as “reed cane”, which is most often found in conditions of alkaline soil, hot weather, sandy earth, and poor drainage. Arundo donax sprouts twice within a calendar year, with only the earlier growth being suitable for reed making. The conventional time for harvest in the Northern Hemisphere is mid-December through March. Conditions must have been cold for several weeks, which allows the sap in the cane stem to return to the rhizome portion of the plants in the ground. When harvested too early, the sap remains and the cane stems take on a greenish color which no amount of drying or soaking can eliminate.

Conventionally, the plants are permitted to grow for about two years to maturity, and then harvested during the winter by cutting the stems near the ground and cutting the approximately top ⅓, keeping a pole of about 2.5-3 meters in length. The poles with leaves attached, are gathered in bundles for air drying in an open field for about 120 days. The dried poles are then dehusked (dried leaves removed from the nodes) using a specialized machine and the dehusked poles are laid down horizontally in the open field for sunning over a period of about 30-days. The sunning requires rotation of the poles every other day to assure even exposure to the sunlight. The nodes are then cut from the poles, leaving the inter-node portions of the stems as individual tubes of a length typically in the range of 2-6 inches. These tubes are then inspected and shipped as finished tube segments.

The reed maker selects finished tubes according to length and thickness for the intended instrument, and splits the tubes into blanks. Some musicians prefer to prepare their own reeds from these blanks, whereas the large majority of musicians purchase finished reeds.

It can be appreciated that the processing of cane reed from the time of harvest to the shipping of finished reed tubes, is labor intensive and inefficient. The present inventor has had first hand experience with such conventional process and has discovered a significant improvement thereover.

### SUMMARY

According to the present invention, during harvesting of the cane plant, each plant is trimmed by removing the nodes and associated leaves, thereby forming raw tubes from each remaining internode segment. The raw tubes are artificially dried and then exposed to artificial light, to produce finished tubes.

The improved process reduces the time between the harvesting of a plant to the completion of a finished tube, from a period that is typically measured in months to a period measured in weeks. Furthermore, it has been found that the artificial drying is so effective that harvesting and processing of the reed cane can continue throughout the year, thereby increasing productivity and responsiveness to fluctuations in demand.

Preferably, the raw tube segments are stacked or arranged in a sheltered building on the plantation where a fan or similar device provides a constant, low velocity flow of ambient air. Drying in this manner can be accomplished in 7-10 days, relative to the 120-days of the conventional drying process.

The dried tubes are preferably stacked in a rack, conveyor or the like where they can be manually or automatically rotated in the presence of artificial light for a period of 15-20 days, which is also significantly less than the 30-days typical of the conventional process.

In essence, the cane plants are severed from the ground, the nodes (and associated leaves) removed, such that the resulting plurality of internode portions or segments of the stem immediately form raw reed tubes. These are small in size, easily accumulated and transported out of the field, and conveniently stored in a holding bin or the like until artificial drying. Moreover, with the present invention, the conventional step of dehusking the dried poles is not required.

### BRIEF DESCRIPTION OF THE DRAWING

FIG. 1 is a schematic representation of a reed cane plant immediately after severing of the stem from the rhizome and trimming of the top of the stem;

FIG. 2 is a schematic representation of the removal of the nodes at the time of harvest, thereby producing a multiplicity of raw tube segments in accordance with the present invention;

FIG. 3 is a simplified block diagram of the process steps for the further processing of the raw tubes depicted in FIG. 2; and

FIG. 4 is a chart comparing the conventional and inventive processes.

### DETAILED DESCRIPTION

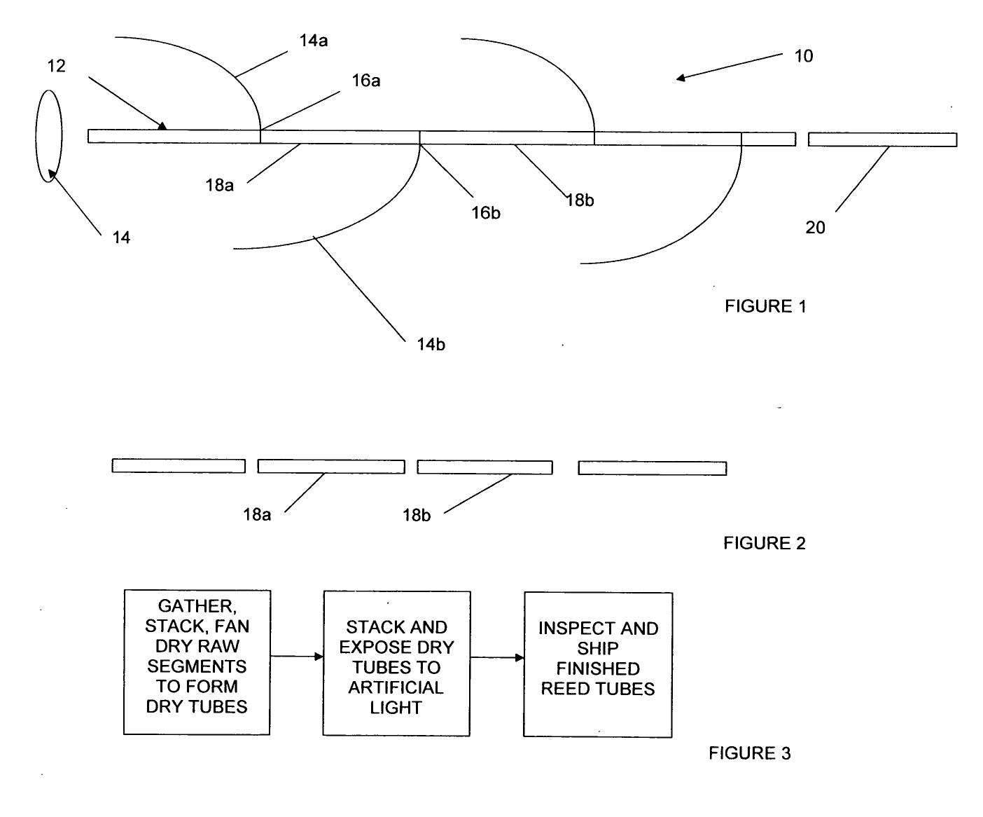

The detailed description of the preferred process can be better understood with reference to the accompanying FIGS. 1-4. FIG. 1 is a representation of a wild Arundo donax plant 10 after the stem 12 has been severed near ground level from the root or rhizome 14. The stem 12 includes a plurality of leaves such as 14a, 14b which grow outwardly from the stem at points or locations 16a, 16b which are typically referred to as nodes. The portions of the stem between nodes are typically referred to as internodes. As an example, internodes 18a and 18b are shown relative to nodes 16a and 16b. While the stem is in the field, the approximately top ⅓ indicated at 20 is severed, leaving the remainder at a typical length of 2.5-3 meter and a stem diameter of at least about 24 mm.

In an aspect of the present invention, the nodes such as 16a, 16b are also removed in the field, thereby also removing the associated leaves such as 14a, 14b and converting the elongated pole into a plurality of raw tubes or segments such as indicated at 18a, 18b in FIG. 2. This is most convenient while the particular worker has hold of the plant 10 after detaching from the rhizome 14 and having severed the upper portion 20. However, the accumulation of the pole with nodes 16 and leaves 14 intact for systematic removal of the nodes soon after harvesting, is also within the scope of the present invention. Whereas conventionally, the cutting out of the nodes 16 to form tube segments from the internodes 18 occurs approximately 150-200 days after harvesting, drying, and sunning of a particular plant, with the present invention, the internode tubes 18 are extracted essentially immediately, by at most weeks, not months after harvesting, before drying.

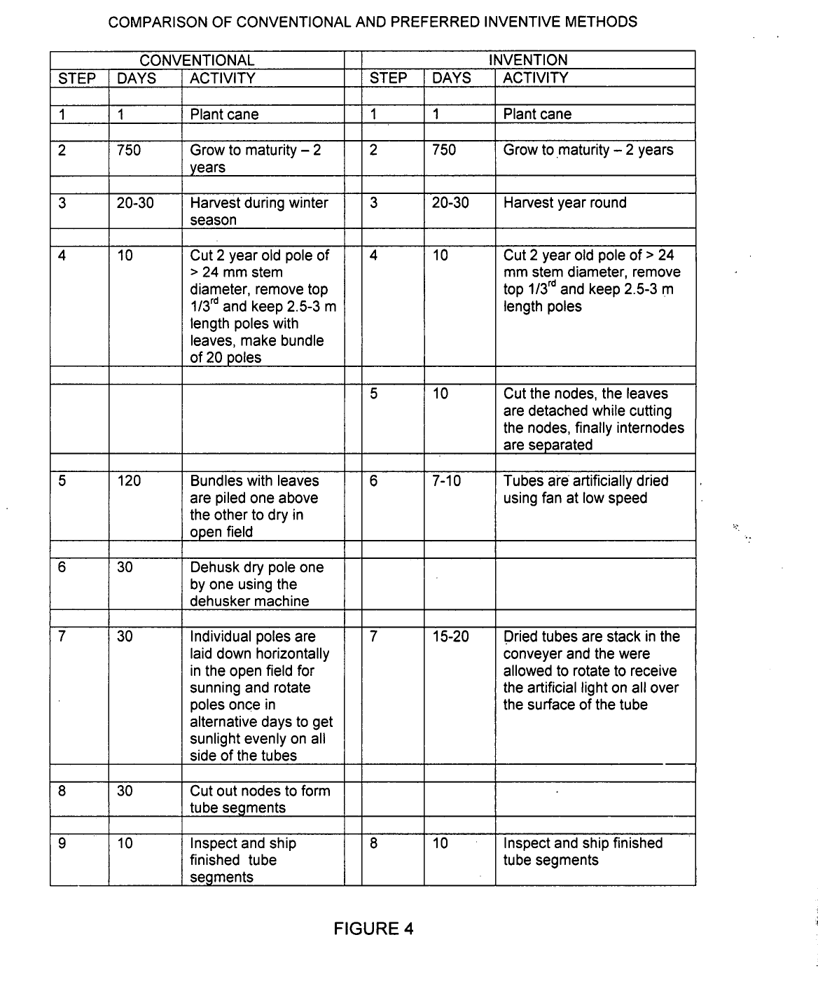

As summarized in FIGS. 3 and 4, the raw tubes shown in FIG. 2, are gathered and artificially dried, then exposed to artificial light with periodic rotation, until they have reached a sufficient level of dryness and coloration to be inspected and shipped as finished reed tubes.

Drying can be achieved with ambient air in a sheltered building, with a low air flow rate, in a period of as few as 5 days, but typically 7-10 days. The artificial sunning can be completed in as few as 10 days, but typically 15-20 days.

It is a characteristics of Arundo donax that the somewhat crispy, fibrous material in the otherwise hollow center, dries quickly and does not present a significant resistant to flow of drying air through the tube. The tubes are typically arranged or stacked in parallel to the direction of air movement within the building, i.e., substantially parallel to the fan rotation axis, such that air moves both over the exteriors and through the hollow center of the tubes.

Because the artificial drying and sunning accelerate the production to such a large degree, it has been found that harvesting and processing of the cane plant can proceed year round. In other words, the drying is so effective even over such a short time period, that cane harvested with what would otherwise be considered an excessive level of sap, can nevertheless be dried to essentially the same extent as cane that has been harvested during the winter months.

Thus, another aspect of the present invention is directed to a method of operating a cane processing plant on a cane plantation having a field of cane plants suitable for the manufacture of musical instrument reeds, where the harvesting is continual throughout the year. Each harvested plant is trimmed and cut into internode segments, thereby forming raw tubes. The raw tubes are first artificially dried in a sheltered building on the plantation, and the artificially dried tubes are exposed to artificial light in a sheltered building on the plantation.

It can be appreciated that, as indicated above, the time period between the initial cutting of the stem from the rhizome and removal of the top portion as shown in FIG. 1, to the removal of the nodes to arrive at a plurality of internode segments such as shown in FIG. 2, can be as short as a few seconds, in the field, or can be spaced apart at different locations in or near the field, but in any event, the raw tubes are gathered and brought to a central location, typically adjacent to the buildings where artificial drying and sunning are to be performed. The raw tubes can be warehoused or kept in a holding bin as temporary inventory, to the extent the drying and sunning operations proceed at a slower rate than the harvesting and trimming. Thus, the invention can include a further step of accumulating or storing the raw tubes until they can be delivered to the drying station.

Although drying can be performed with the raw tubes simply lying side by side on the building floor, a more desirable condition, is that the tubes are supported on racks or the like, having multiple spaced apart layers. While drying, the tubes can be stationary or the racks can be translated slowly in a process direction such that the racks enter the sunning building at the completion of the drying stage, and continue to convey the dried tubes through the sunning building. Most conveniently, however, the raw tubes are brought into the drying building and manually arranged or stacked on a rack where they remain for a period of 7-10 days while exposed to a substantially continuous flow of air driven by one or more fans. Upon confirmation via inspection that the drying has been completed, the dried tubes are manually gathered, deposited in a receptacle, and brought to another building where they are arranged on racks or the like where they can be periodically rotated while exposed to artificial light. Upon the completion of the sunning for that batch, all of the tubes are gathered and then individually inspected before packaging and shipping as finished tube products.

The drying can be performed inside a typical warehouse using a typical cooling fan run at slow speed, with ambient temperature (e.g., 27° C.), and the sunning can also be performed inside a green house at a temperature of 35-40° C. (e.g., with metal halide, 400 W, 400-700 nanometers). It is not necessary that an elaborate environmental control system be utilized to maintain temperature, humidity, and air flow rate at optimum levels. However, if the time required for complete processing is to be shortened to the extent possible, air heating units can be associated with the fan or drying building, with the air temperature monitored and the humidity of the ambient air and the ventilated air also monitored. A database or chart relating these variables to drying rate can be utilized by the operator.

The following paragraphs summarize experiments that demonstrate the effectiveness of the present invention.

Experiment I (Off-Season/with Sap/Summer)
Canes from plantation in Argentina
3 green canes were harvested from the plantation field with nodes and internodes
Age of the cane 16 months, harvested in December
Moisture content in the cane is >70% at the time of harvest
Nodes removed immediately after harvest
25 tubes dried by fan at room temperature for 1 week
Moisture dropped to <15% in 7-10 days; tubes turned into light green color
0% shriveling, no staining on tubes, clean tubes
Artificially sunned using metal halide light (400 W) for 2 weeks; tubes turned into medium yellow color
Total duration of curing time: 24 days
Finished tubes tested for playability
Comments from musicians: Good sound and strength, no smell from the reeds

Experiment II (Off-Season/with Sap/Summer)
Canes from plantation in Argentina
20 poles (200 tubes) harvested in December, age 16 months
Followed the procedure of Experiment I
Obtained the same results.

Experiment III France (In-Season/No Sap/Winter)
Canes from plantation in France
10 poles harvested in December, age 24 months
Followed the procedure of Experiment I
Obtained the same results

Experiment IV China (In-Season/No Sap/Winter)
Canes from plantation in China
2 poles (20 tubes) harvested in December, age 24 months
Followed the procedure of Experiment I
Obtained the same results

These experiments show that whether the harvest was in off-season (December/summer in Argentina) of conventionally immature plants, or conventionally mature plants in-season (December/winter in France and China), the artificial drying and sunning of pre-cut internodal tubes according to the invention reduces the moisture content from over 70% to less than 15%. Standard moisture content for finished tubes is <15%.

With the inventive methods as represented by these experiments, the artificial drying and sunning produced finished tubes in 24 days, whereas the traditional method would have taken 4-5 months. Not only is the required time reduced by about three months, but the finished tubes were of high quality, with no stains (conventionally a problem due to mold infection), no shriveling, and with good playability for both in and off-season harvest. Moreover, continual harvesting or harvesting as needed in any season, can better match inventory with the demand for finished tubes.

1. A method for producing reed tubes from cane plants comprising:
(a) harvesting cane plants by severing from the roots at substantially ground level;
(b) removing nodes from each severed plant such that the resulting internodes constitute a plurality of raw tubes from each plant;
(c) artificially drying the raw tubes in a sheltered building; and
(d) artificially sunning the dried tubes in a sheltered building to produce finished tubes.

2. The process of claim 1, wherein step (c) of drying the raw tubes includes passing drying air at low velocity over and through the hollow center of the raw tubes.

3. The process of claim 2, wherein the drying air has a flow rate that is substantially constant for a period of at least five days.

4. The method of claim 1 wherein step (c) of drying the raw tubes comprises generating a flow of artificially heated air over the exterior and through the hollow center of each raw tube.

5. The method of claim 1, wherein step (c) includes continually conveying a multiplicity of tube segments though a drying room.

6. The method of claim 1, wherein the artificial light is a metal halide light.

7. The method of claim 1, wherein
step (c) of drying includes continuously operating a fan to move ambient air through the building until the moisture content of the raw tubes is less than about 15%; and
step (d) includes periodic rotation of the dried tubes while continuously exposed to artificial light.

8. The method of claim 7, wherein the artificial drying step (c) is performed over a period of about 7-10 days and the artificial sunning step (d) is performed over a period of about 10-20 days.

9. A method for producing reed tubes from cane plants comprising:
(a) harvesting cane plants by severing from the roots at substantially ground level;
(b) trimming each harvested plant to remove a top portion, thereby forming poles, each pole having a plurality of longitudinally spaced apart nodes and internodes;
(c) removing the nodes such that the resulting internodes constitute a plurality of raw tubes;
(d) artificially drying the raw tubes in a sheltered building; and
(e) artificially sunning the dried tubes in a sheltered building to produce finished tubes.

10. The method of claim 9, wherein
the artificial drying step (d) includes forcing ambient air at low velocity over the tubes for a period of about 7-10 days until the moisture content of the tubes is below about 15%; and
the artificial sunning step (e) is performed for a period of about 10-20 days during which the tubes are rotated.

11. A method of operating a cane processing plant on a cane plantation having a field of cane plants suitable for the manufacture of musical instrument reeds, comprising:
(a) harvesting cane plants continually throughout the year;
(b) trimming each harvested plant to form poles, each pole having a plurality of longitudinally spaced apart nodes;
(c) removing the nodes whereby each pole is converted into a plurality of raw tube segments;
(d) artificially drying each raw tube segment in a sheltered building on the plantation; and
(e) artificially sunning each tube segment in a sheltered building on the plantation.

12. The method of claim 11, wherein steps (a) and (b) are performed substantially simultaneously in the field, and step (c) is performed as a separate operation in the field or outside said sheltered buildings.

13. The method of claim 11, wherein between steps (c) and (d) the raw tube segments are stored in a sheltered building.

14. The method of claim 11, wherein in step (d) of artificially drying the tube segments are placed on a rack spaced apart from each other and the tube segments are dried while on the rack.

15. The method of claim 11, wherein step (d) of artificially drying includes operating a fan to move ambient air at low velocity through the building.

16. The method of claim 15 wherein step (d) of artificially drying is performed while the tube segments are on a rack.

17. The method of claim 15, wherein the step (e) of artificial sunning is performed while the dried tube segments are on a rack.

18. The method of claim 11, wherein the drying step (d) is performed in a room having a controlled environment of at least one of temperature and humidity.

19. The method of claim 18, wherein step (d) of drying comprises forming a flow of artificially heated air over and through the hollow centers of the tube segments.

20. The method of claim 11, wherein
step (d) of drying includes continuously operating a fan to move ambient air through the building until the moisture content of the raw tubes is less than about 15%; and
step (e) includes periodic rotation of the dried tubes while continuously exposed to artificial light.

21. The method of claim 11, wherein the artificial drying step (d) is performed over a period of about 7-10 days and the artificial sunning step (e) is performed over a period of about 10-20 days.
